(19) United States
(12) Patent Application Publication
(10) Pub. No.: US 2025/0315075 A1
(43) Pub. Date: Oct. 9, 2025

(54) FORCE SENSING FOUR-WAY SELECTOR SWITCH WITH MECHANICAL HAPTIC FEEDBACK

(71) Applicant: Kostal of America, Inc., Troy, MI (US)

(72) Inventors: Steven R. Hoskins, Wolverine Lake, MI (US); Kenneth S. Koscielniak, Farmington Hills, MI (US); Peter G. Elphick, Rochester, MI (US)

(73) Assignee: Kostal of America, Inc., Troy, MI (US)

(21) Appl. No.: 19/079,588

(22) Filed: Mar. 14, 2025

Related U.S. Application Data
(60) Provisional application No. 63/631,696, filed on Apr. 9, 2024.

(51) Int. Cl. G05G 9/047

(52) U.S. Cl. CPC G05G 9/047; G05G 2009/04762; G05G 2009/04766

(57) ABSTRACT

A four-way selector switch, suitable for various automotive applications, including mirror position switches, turn signal switches, wiper/washer switches, storing column tilt/position switches, and electronic gear selectors, have a lever pivotably mounted on a base, two force sensors oriented orthogonally to each other, a mechanical detent system, and a processor for evaluating user input to generate an appropriate control signal.

### CROSS-REFERENCE TO RELATED APPLICATIONS

This application claims priority to U.S. Provisional Application No. 63/631,696, filed on Apr. 9, 2024, which is incorporated herein by reference in its entirety.

### FIELD OF THE DISCLOSURE

This disclosure generally relates to force sensing selector switches having a stick-type user interface that provides haptic feedback, and more particularly to such switches using non-mechanical means for detecting switch position and mechanical means for providing haptic feedback to the user.

### BACKGROUND OF THE DISCLOSURE

Four-way stick-type selector switches used in automotive applications, such as for adjusting mirror position, controlling turn signals, controlling steering wheel and steering column tilt and position, windshield wiper and washer operation, and electronic gear selectors, generally require a minimal or small amount of angular displacement relative to the neutral position of the selector switch. The small displacement requirements combined with the cantilevered structure of these types of selector switches present challenges for achieving long term reliability in detecting switch position while providing the user with haptic feedback indicating that the intended operation has been recognized by the selector switch.

### SUMMARY OF THE DISCLOSURE

A four-way selector switch in accordance with this disclosure includes a lever that is pivotably mounted on a base, two force sensors oriented orthogonally to each other to measure force applied to the lever, a mechanical detent system providing haptic feedback to a user operating the lever, and a processor for evaluating user input to the lever and generating an appropriate signal to effect a desired operation indicative of the user's manipulation of the switch.

In certain embodiments, the force sensors can be digital strain gauges.

In some embodiments, the mechanical detent system includes a spring-loaded plunger interacting with a detent plate.

The lever can be pivotably mounted to the base with a universal joint, or with a ball joint.

The force sensors can, in certain embodiments, be inductive sensors or piezoresistive sensors,

### BRIEF DESCRIPTION OF THE DRAWINGS

FIG. 1 is a perspective view of a four-way selector switch assembly in accordance with this disclosure in which portions of a housing of the selector switch assembly are broken away to show a plunger pocket

FIG. 2 is an enlarged perspective view of the plunger pocket and associated features.

FIG. 3 is a perspective view similar to FIG. 1, in which portions of the selector switch assembly are broken away to show internal structure of the plunger pocket.

FIG. 4 is a schematic illustration of a sequence of events or steps that occur in a process for generating a control signal to affect a desired operation based on user actuation of the switch.

FIG. 5 is a diagram that illustrates sensor signals being processed by the digital signal processor.

FIG. 6 is a schematic diagram illustrating processing of signals received from force sensors on the selector switch for a turn-signal switch system to correlate user manipulation with an intended operation.

FIG. 7 is a graph illustrating digital signal processor output of sensor measurements compared to haptic response.

### DETAILED DESCRIPTION

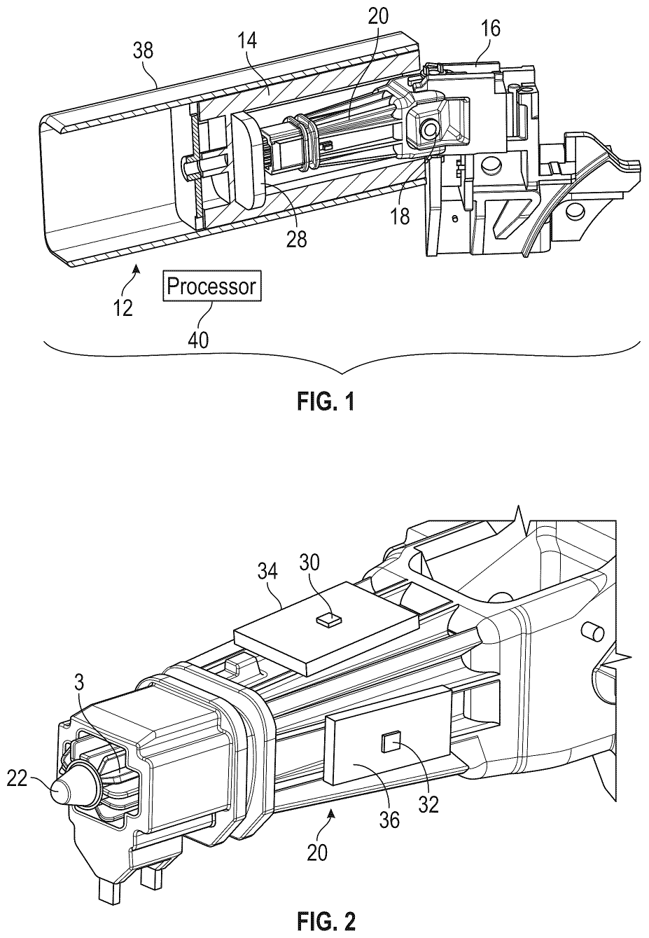

The disclosed four-way selector switch device 10 is designed to provide mechanical haptic feedback means that operate independently of non-mechanical means for detecting the user intended operation based on sensing the position and/or orientation of a stick-or lever-type human-machine interface 12, while reliably coordinating haptic feedback with the intended user operation. As shown in FIG. 1, a lever 14 is pivotably mounted to a base 16 for pivoting around two orthogon axes. For example, lever 14 can be pivotably mounted to base 16 to allow pivoting of lever 14 upwardly, downwardly, forwardly and rearwardly into one of four positions, each of which can correspond to a particular operation. As an example, urging the lever up could correspond to tilting a sideview mirror upwardly, down corresponding with tilting the mirror downwardly, and left and right corresponding with tilting the mirror left and right, respectively.

The pivotable or articulated connection between lever 14 and base 16 can be achieved with an articulating joint 18, such as a universal (Cardan) joint. As another example, joint 18 can be a ball joint that can be used with a plus-sign shaped restrictor gate that limits pivoting of lever 14 around orthogonal axes.

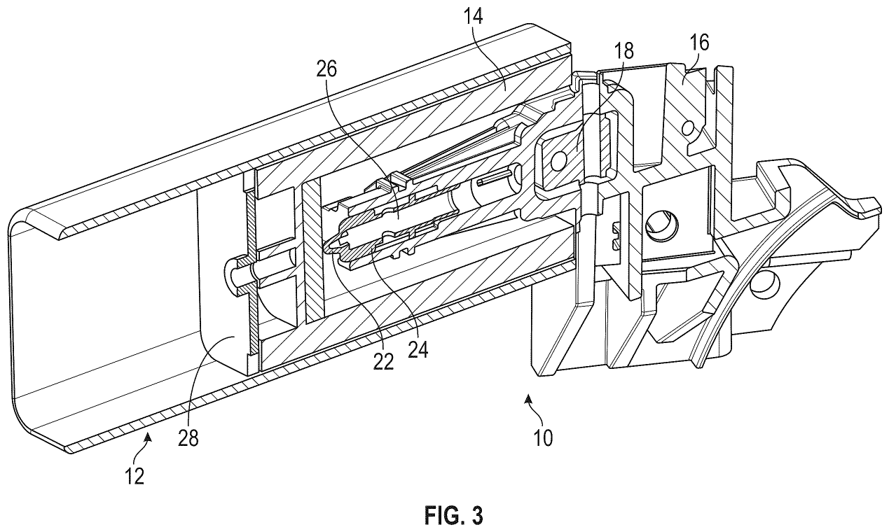

Fixedly attached to base 16 is a plunger housing or body 20 having a detent engaging ball or tip portion 22 at its distal end (FIGS. 2 and 3). Body 20 also defines a guideway for a plunger portion 24 that is biased toward the distal direction by a spring 26 which urges tip portion 22 toward and into engagement with a detent plate 28. Detent plate 28 includes a plurality of detents (not shown) that catch the tip portion 22 of the plunger to provide haptic feedback to the user indicating that a selected operation has been affected.

While plunger 24 and detent plate 28 provide a simple mechanical means for indicating to the user that a selected operation has been affected, these mechanical means do not directly generate any control signals and are not mechanically linked to devices that perform the desired operation. Rather, movement of lever 14 corresponding to a desired operation by the user is detected using orthogonally oriented force detecting sensors 30, 32, each of which is mounted on a corresponding circuit board 34, 36, respectively, which are in turn mounted orthogonally on plunger housing 20. Force sensors 30, 32 can, for example, be digital strain gauges, inductive sensors, piezoresistive sensors, piezoelectric sensors, or capacitive sensors.

A decorative cover or sheath 38 can be provided to achieve a desired aesthetic appearance.

The disclosed switch device 10 includes a processor 40 (represented schematically) for receiving force signals (measurements) from each of sensors 30 and 32, determining an intended operation based on the force measurements, and generating a control signal for performing the intended operation.

The disclosed switch can include a processor configured to execute a digital signal processing algorithm that is used for processing and analyzing digital signals created by measuring mechanical impulses (i.e., surface strain).

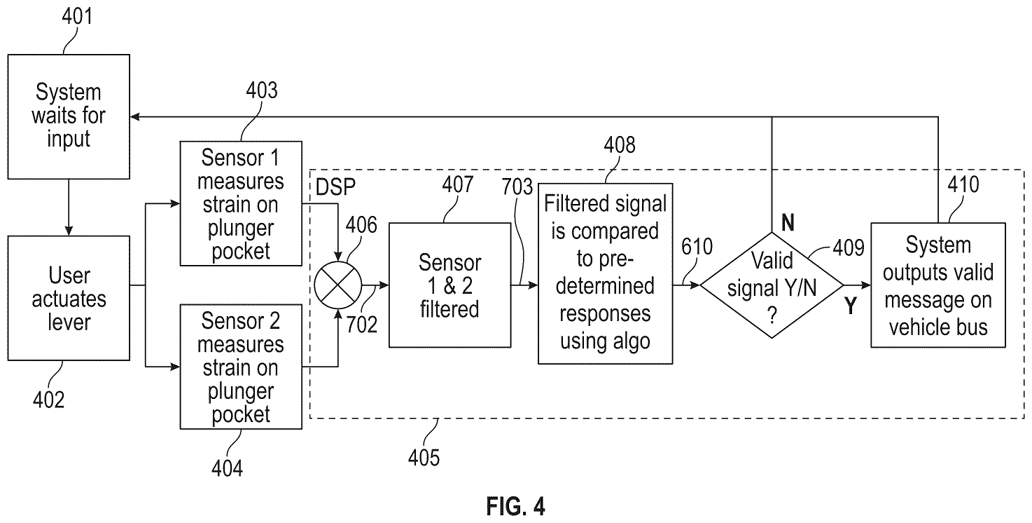

FIG. 4 shows a sequence of events or steps that occur in a process for analyzing user or random input generated by the force sensors 30, 32 when the lever 14 is deliberately or inadvertently displaced from a neutral position and providing a control signal to effect a desired operation of the user when the input is recognized as a deliberate lever movement corresponding with an intended operation. At step 401, the system waits for a movement of lever 14 that generates digital signals from sensors 30, 32. At step 402, a user deliberately or inadvertently applies force to lever 14 causing sensors 30, 32 to output digital signals at steps 403 and 404. Signals from the sensors are input to a digital signal processor 405. The digital signals are combined or mixed at digital mixer 406. The combined output signal from digital mixer 406 is filtered and compared with pre-determined responses at filter 407 and comparator 408. At step 409, the system is reset to wait for further input if the filtered signal is not recognized as corresponding with a deliberate user command, or the system outputs a command to perform an operation if the filtered signal corresponds with a valid command at step 410 (and the system is reset to wait for further input).

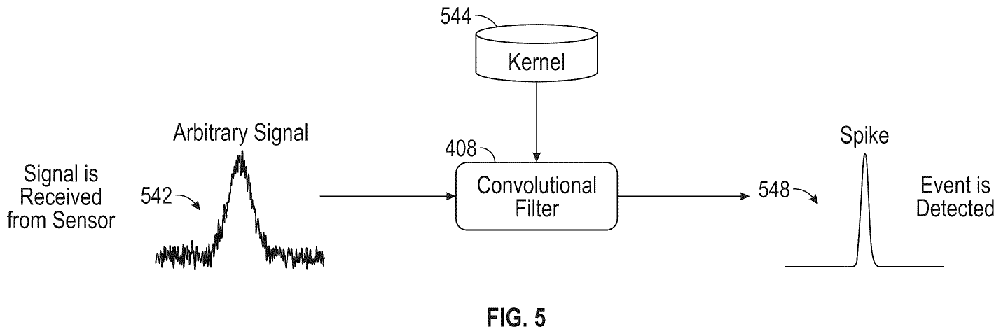

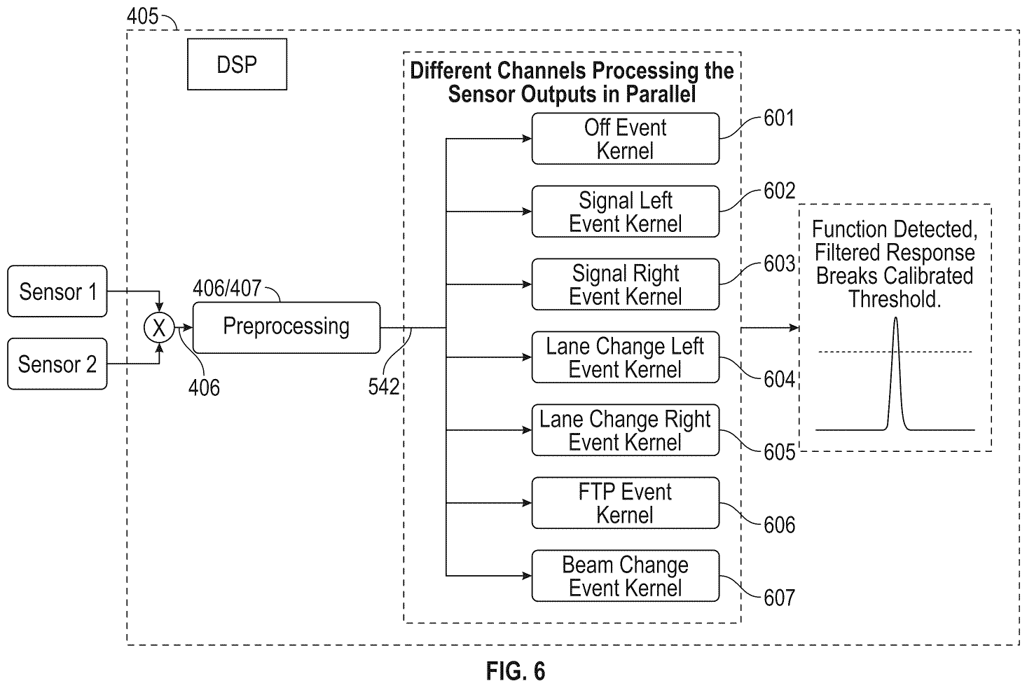

FIG. 5 shows a filtered signal 542 transmitted from filter 407 to comparator 408 (convolutional filter). Signal 542 is compared with predetermined responses (kernels 544). If filtered signal 542 matches a recognized kernel 544, an output control signal 548 corresponding to a desired command is generated. FIG. 6 shows an example, in which a filtered signal 542 is used for a turn-signal switch system. Signal 542 is compared with kernels 601 through 607, corresponding to off, turn signal left, turn signal right, lane change left, lane change right, flash-to-pass, and beam change, respectively. If there is sufficient correspondence (i.e., exceeding a predetermined threshold) between filtered signal 542 and one of kernels 601-607, an output command 610 is generated.

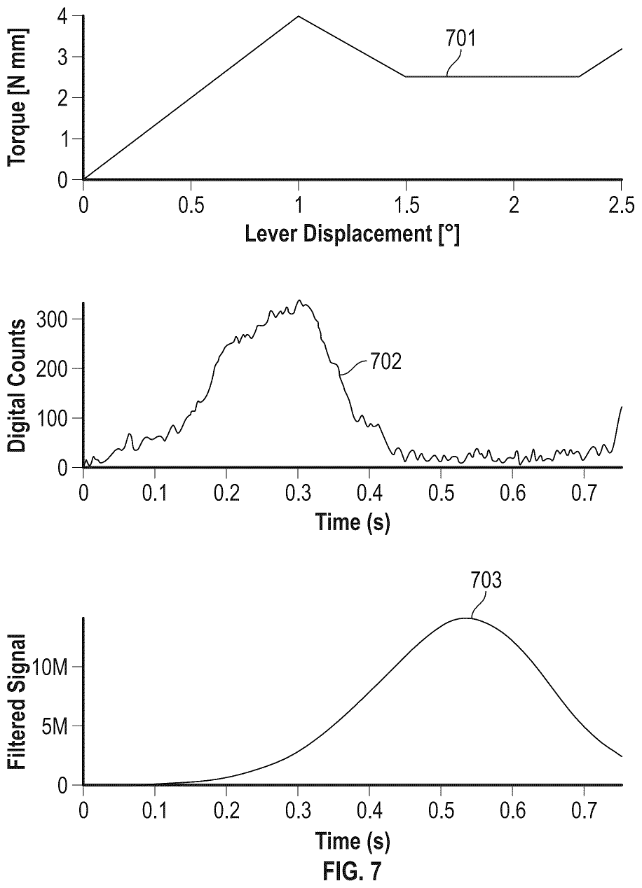

In FIG. 7, there is shown a relationship among lever displacement torque 701, force sensor output 702 from digital mixer 406, and filtered signal output 703 from filter 407. Torque 701, signal 702 and, signal 703 are all on the same time scale.

The above description is intended to be illustrative, not restrictive. The scope of the invention should be determined with reference to the appended claims along with the full scope of equivalents. It is anticipated and intended that future developments will occur in the art, and that the disclosed devices, kits and methods will be incorporated into such future embodiments. Thus, the invention is capable of modification and variation and is limited only by the following claims.

1. A four-way selector switch with haptic feedback, comprising:
a lever, pivotably mounted on a base;
two force sensors on the lever arranged orthogonally to each other to measure force applied to the lever; and
a mechanical detent system providing haptic feedback when the lever is pivoted.

2. The switch of claim 1 further comprising, a computer processor receiving force measurements from the two force sensors and determining a user intended operation based on the force measurements.

3. The switch of claim 1, wherein the two force sensors are digital strain gauges.

4. The switch of claim 1, wherein the mechanical detent system comprises a spring and plunger interacting with a detent plate.

5. The switch of claim 1, wherein the lever is pivotably mounted to the base with a universal joint.

6. The switch of claim 1, wherein the lever is pivotably mounted to the base with a ball joint.

7. The switch of claim 1, wherein the processor is configured to process the force measurements through a convolutional filtering algorithm.

8. The switch of claim 1, wherein the processor is configured to process the force measurements using a digital signal processor.

9. The switch of claim 1, wherein the two force sensors are inductive sensors.

10. The switch of claim 1, wherein the force sensors are piezoresistive sensors.

11. The switch of claim 1, wherein the force sensors are piezoelectric sensors.

12. The switch of claim 1, wherein the force sensors are capacitive sensors.

13. A method for evaluating forces on a four-way selector switch with haptic feedback to determine user intent, comprising:
providing a four-way selector switch in accordance with claim 1;
measuring force at each force sensor and generating a digital output signal from each force sensor;
combining the digital output signals from each of the force sensors to generate a mixed signal;
filtering the mixed signal;
comparing the filtered mixed signal with a kernel at a comparator; and
generating an output signal from the comparator when correspondence between the filtered mixed signal and a kernel exceed a predetermined threshold.
